(19) United States
(12) Patent Application Publication
(10) Pub. No.: US 2026/0266779 A1
(43) Pub. Date: Sep. 10, 2026

(54) ELECTROSPRAY EMITTER SYSTEMS AND USES THEREOF

(71) Applicant: Ion Opticks Research Pty Ltd, Collingwood (AU)

(72) Inventors: Jarrod John Sandow, Brunswick West (AU); Todd David Blackburn, JR., Southbank (AU); Andreia Filipa Ferreira De Almeida, Reservoir (AU); Aaron George Poth, Morayfield (AU); Greta Briedyte, Windsor (AU); Daniela-Lee Smith, Point Cook (AU); Paul Scott Griffiths, Ashwood (AU); Dimitrios Matthew Papadopoulos, Seaford (AU); Brendyn Murray Rodgers, Blackburn (AU)

(21) Appl. No.: 19/556,542

(22) Filed: Mar. 4, 2026

Related U.S. Application Data
(60) Provisional application No. 63/767,950, filed on Mar. 6, 2025.

(51) Int. Cl. G01N 30/72

(52) U.S. Cl. CPC G01N 30/7266

(57) ABSTRACT

Electrospray emitter systems for use in liquid chromatography with mass spectrometry are provided herein. An electrospray emitter system may comprise a capillary column with an emitter. The electrospray emitter system may be configured to emit a fluid to a mass spectrometry system and may be configured to have an electrical path from the mass spectrometry system to the distal end of the capillary column.

### CROSS REFERENCE

This application claims the benefit of U.S. Provisional Application No. 63/767,950 filed Mar. 6, 2025, which application is incorporated herein by reference in its entirety.

### BACKGROUND

Chromatography is a technique for separating components of a fluid mixture for subsequent analysis and/or identification. For example, the subsequent analysis may be mass spectrometry, which requires ionization of the components. Standard approaches for combining liquid chromatography and mass spectrometry have utilized many separate components that are often assembled by the end user. For instance, systems frequently include separate capillary columns for separating components and emitters for electrospray ionization of the components into the mass spectrometry system. However, end user assembly can result in suboptimal connection between various components. Therefore, ready-made systems for liquid chromatography with electrospray emitter capabilities are desired.

### SUMMARY

In one aspect, this disclosure provides an electrospray emitter system comprising: an emitter; a column connected to the emitter; a non-conductive emitter collar comprising non-electrically conductive material, wherein at least of a portion of the emitter or the column are positioned within the emitter collar; and an electrically conductive strip embedded into the emitter collar, wherein the electrically conductive strip provides an electrical path toward the emitter. In some embodiments, the electrically conductive strip is embedded into the outer surface of the emitter collar. In some embodiments, the electrically conductive strip is embedded into the inner surface of the emitter collar. In some embodiments, the electrospray emitter system further comprises a voltage bridge and an electrically conductive fitting. In some embodiments, the electrically conductive strip, the voltage bridge, and the electrically conductive fitting are interfacing such that the electrically conductive strip, the voltage bridge, and the electrically conductive fitting operate as the electrical path. In some embodiments, the electrically conductive strip comprises a high voltage contact point. In some embodiments, the high voltage contact point comprises a recess for interfacing with a mass spectrometry system. In some embodiments, the high voltage contact point is outwardly exposed in relation to the emitter collar. In some embodiments, the column and the emitter are integrally connected as a single component. In some embodiments, the emitter comprises a packed-tip emitter.

In another aspect, this disclosure provides an electrospray emitter system comprising: an emitter; a column connected to the emitter; a non-conductive emitter collar comprising non-electrically conductive material, wherein at least of portion of the emitter or the column are positioned within the emitter collar; and an electrically conductive rail, wherein the electrically conductive rail is mounted to the emitter collar, and wherein the electrically conductive rail provides an electrical path toward the emitter. In some embodiments, the electrically conductive rail is mounted to the outer surface of the emitter collar. In some embodiments, the electrically conductive rail is mounted to the inner surface of the emitter collar. In some embodiments, the electrospray emitter system further comprises a voltage bridge and an electrically conductive fitting. In some embodiments, the electrically conductive rail, the voltage bridge, and the electrically conductive fitting are interfacing such that the electrically conductive rail, the voltage bridge, and the electrically conductive fitting operate as the electrical path. In some embodiments, the electrically conductive rail comprises a high voltage contact point. In some embodiments, the high voltage contact point comprises a recess for interfacing with a mass spectrometry system. In some embodiments, the column and the emitter are integrally connected a single component. In some embodiments, the emitter comprises a packed-tip emitter.

In another aspect, this disclosure provides an electrospray emitter system comprising: an emitter; a column connected to the emitter; a non-conductive emitter collar comprising non-electrically conductive material, wherein at least of a portion of the emitter or the column are positioned within the emitter collar; and an electrically conductive inner frame, wherein the electrically conductive inner frame is positioned within the emitter collar and around at least a portion of the emitter or the column, and wherein the electrically conductive inner frame provides an electrical path toward the emitter. In some embodiments, the electrically conductive inner frame is hollow. In some embodiments, the electrically conductive inner frame comprises one or more cut outs. In some embodiments, the electrospray emitter system further comprises a voltage bridge and an electrically conductive fitting. In some embodiments, the electrically conductive inner frame, the voltage bridge, and the electrically conductive fitting are interfacing such that the electrically conductive inner frame, the voltage bridge, and the electrically conductive fitting operate as the electrical path. In some embodiments, the electrically conductive inner frame comprises a high voltage contact point. In some embodiments, the emitter collar has an aperture configured to outwardly expose the high voltage contact point. In some embodiments, the aperture and the high voltage contact point are configured to interface with a mass spectrometry system. In some embodiments, the electrically conductive inner frame comprises a contact groove for interfacing with a mass spectrometry system. In some embodiments, the electrospray emitter system further comprises an electrically conductive ring. In some embodiments, the electrically conductive ring is located around the proximal end of the emitter collar. In some embodiments, the electrically conductive ring is a press-fit or threaded ring. In some embodiments, the electrically conductive ring comprises a groove for interfacing with a mass spectrometry system. In some embodiments, the electrically conductive ring, the electrically conductive inner frame, the voltage bridge, and the electrically conductive fitting are interfacing such that the electrically conductive ring, the electrically conductive inner frame, the voltage bridge, and the electrically conductive fitting operate as the electrical path. In some embodiments, the column and the emitter are integrally connected as a single component. In some embodiments, the emitter comprises a packed-tip emitter.

An electrospray emitter system comprising: an emitter; a column connected to the emitter; and an electrically conductive column holder providing an electrical path toward the emitter, wherein at least a portion of the column interfaces with the column holder. In some embodiments, the electrospray emitter system further comprises an electrically conductive fitting and at least one other electrically conductive component. In some embodiments, the at least one other electrically conductive component is one or more of an emitter collar, an electrically conductive strip, an electrically conductive rail, or an electrically conductive inner frame. In some embodiments, the column holder comprises a first side of a claw clip. In some embodiments, the at least one other electrically conductive component, the electrically conductive column holder, and the electrically conductive fitting are interfacing such that the at least one other electrically conductive component, the electrically conductive column holder, and the electrically conductive fitting operate as the electrical path. In some embodiments, the electrospray emitter system further comprises an electrically conductive cover plate. In some embodiments, the at least one other electrically conductive component, the electrically conductive column holder, the electrically conductive cover plate, and the electrically conductive fitting are interfacing such that the at least one other electrically conductive component, the electrically conductive column holder, the electrically conductive cover plate, and the electrically conductive fitting operate as the electrical path. In some embodiments, the column and the emitter are integrally connected a single component. In some embodiments, the emitter comprises a packed-tip emitter.

In some embodiments, the electrospray emitter system may comprise an electrospray emitter enabled chromatographic system.

Additional aspects and advantages of the present disclosure will become readily apparent to those skilled in this art from the following detailed description, wherein only illustrative embodiments of the present disclosure are shown and described. As will be realized, the present disclosure is capable of other and different embodiments, and its several details are capable of modifications in various obvious respects, all without departing from the disclosure. Accordingly, the drawings and description are to be regarded as illustrative in nature, and not as restrictive.

### INCORPORATION BY REFERENCE

All publications, patents, and patent applications mentioned in this specification are herein incorporated by reference to the same extent as if each individual publication, patent, or patent application was specifically and individually indicated to be incorporated by reference. To the extent publications and patents or patent applications incorporated by reference contradict the disclosure contained in the specification, the specification is intended to supersede and/or take precedence over any such contradictory material.

### BRIEF DESCRIPTION OF THE DRAWINGS

The novel features of the disclosure are set forth with particularity in the appended claims. A better understanding of the features and advantages of the present disclosure will be obtained by reference to the following detailed description that sets forth illustrative embodiments, in which the principles of the disclosure are utilized, and the accompanying drawings of which:

FIG. 1A shows a side view of an exemplary electrospray emitter system, according to embodiments herein.

FIG. 1B shows an exploded view of the electrospray emitter system of FIG. 1A.

FIG. 1C shows a partial cut away side view of an exemplary electrospray emitter system, according to embodiments herein.

FIG. 1D shows a cut away side view of the exemplary electrospray emitter system of FIG. 1D, according to embodiments herein.

FIG. 2A shows a side view of an exemplary electrospray emitter system with an emitter collar and an embedded electrically conductive strip, according to embodiments herein.

FIG. 2B shows a side view of an exemplary electrospray emitter system with an emitter collar and an electrically conductive rail, according to embodiments herein.

FIG. 3A shows a cross-sectional view of an exemplary electrospray emitter system with an emitter collar, an emitter locator, and an electrically conductive inner frame, according to embodiments herein.

FIG. 3B shows an angled side view of the electrospray emitter system of FIG. 3A.

FIG. 3C shows an angled side view of the electrically conductive inner frame of FIG. 3A.

FIG. 4A shows a cross-sectional view of an exemplary electrospray emitter system with an emitter collar, an emitter locator, an electrically conductive inner frame, and an electrically conductive ring, according to embodiments herein.

FIG. 4B shows an angled side view of the electrospray emitter system of FIG. 4A.

FIG. 5A shows a cross-sectional view of an exemplary electrospray emitter system with an emitter collar, an emitter locator, and an electrically conductive inner frame with a contact groove, according to embodiments herein.

FIG. 5B shows an angled side view of the electrospray emitter system of FIG. 5A with the emitter collar shown transparently.

FIG. 5C shows an angled side view of an exemplary electrically conductive inner frame with a contact groove, according to embodiments herein.

FIG. 5D shows an angled side view of an exemplary electrically conductive inner frame with a contact groove, according to embodiments herein.

FIG. 6A shows a cross-sectional view of an exemplary electrospray emitter system with an electrically conductive column holder, according to embodiments herein.

FIG. 6B shows an angled side view of the column holder of FIG. 6A.

FIG. 7A shows a cross-sectional view of an exemplary electrospray emitter system with an electrically conductive column holder and an electrically conductive cover plate, according to embodiments herein.

FIG. 7B shows an angled side view of the cover plate of FIG. 7A.

FIG. 7C shows an angled side view of the column holder of FIG. 7A.

FIG. 8A shows a cross-sectional view of an exemplary electrospray emitter system with a column holder with claw clips, according to embodiments herein.

FIG. 8B shows a magnified cross-sectional view of a claw clip on the column holder of FIG. 8A.

### DETAILED DESCRIPTION

While various embodiments of the present disclosure have been shown and described herein, it will be obvious to those skilled in the art that such embodiments are provided by way of example only. Numerous variations, changes, and substitutions may occur to those skilled in the art without departing from the invention. It should be understood that various alternatives to the embodiments of the present disclosure described herein may be employed.

As used herein, the singular forms “a,” “an,” and “the” include plural references unless the context clearly dictates otherwise. Any reference to “or” herein is intended to encompass “and/or” unless otherwise stated.

As used herein, the term “about” in some cases refers to an amount that is approximately the stated amount, in some cases near the stated amount by 10%, 5%, or 1%, including increments therein, and in some cases, in reference to a percentage, refers to an amount that is greater or less the stated percentage by 10%, 5%, or 1%, including increments therein.

As used herein, the phrases “at least one,” “one or more,” and “and/or” are open-ended expressions that are both conjunctive and disjunctive in operation. For example, each of the expressions “at least one of A, B and C,” “at least one of A, B, or C,” “one or more of A, B, and C”, “one or more of A, B, or C” and “A, B, and/or C” means A alone, B alone, C alone, A and B together, A and C together, B and C together, or A, B and C together.

Whenever the term “at least,” “greater than,” or “greater than or equal to” precedes the first numerical value in a series of two or more numerical values, the term “at least,” “greater than” or “greater than or equal to” applies to each of the numerical values in that series of numerical values. For example, greater than or equal to 1, 2, or 3 is equivalent to greater than or equal to 1, greater than or equal to 2, or greater than or equal to 3.

Whenever the term “no more than,” “less than,” or “less than or equal to” precedes the first numerical value in a series of two or more numerical values, the term “no more than,” “less than,” or “less than or equal to” applies to each of the numerical values in that series of numerical values. For example, less than or equal to 3, 2, or 1 is equivalent to less than or equal to 3, less than or equal to 2, or less than or equal to 1.

Reference throughout this specification to “some embodiments,” “further embodiments,” or “a particular embodiment,” means that a particular feature, structure, or characteristic described in connection with the embodiment is included in at least one embodiment. Thus, the appearances of the phrase “in some embodiments,” or “in further embodiments,” or “in a particular embodiment” in various places throughout this specification are not necessarily all referring to the same embodiment. Furthermore, the particular features, structures, or characteristics may be combined in any suitable manner in one or more embodiments.

In addition, where dimensions are described herein, it will be appreciated that plus or minus (±) typical manufacturing tolerances are applicable to those values. As appreciated by those in the art, manufacturing tolerances may be determined to achieve a desired mean and standard deviation of manufactured components in relation to the ideal component profile.

The present disclosure relates to systems and methods, particularly electrospray emitter systems for use in liquid chromatography with mass spectrometry. In some embodiments, the electrospray emitter systems may comprise an electrospray emitter enabled chromatographic system.

It is desirable for the connection between components in the electrospray emitter systems described herein to be configured to reduce or eliminate any dead volume that may exist in fluid conduits. Dead volumes are volumes within the fluid conduits that are not swept by the mobile phase of the fluid. Dead volumes in a chromatographic system can adversely impact the performance. For example, dead volumes can have significant effects on chromatographic peak widths and peak symmetry, which in some cases may result in errors in identifying or quantifying individual components of the mixture.

Additionally, electrospray ionization of a fluid sample using an electrospray emitter system as described herein may require voltage to be transferred from the mass spectrometry system to the fluid running through the column. Ideally, in a chromatographic system where the chromatography column and electrospray emitter are manufactured from a single piece of silica capillary, the voltage is transferred to the fluid sample at the entrance of a capillary column, at the opposite end as the emitter and the interface with a mass spectrometry system, typically an Ion Source connected to the mass spectrometer. Therefore, voltage is ideally transferred from the interface of the system with the mass spectrometer to the entrance of a capillary column using an electrical path of electrically conductive components. In a chromatographic system where the chromatography column and electrospray emitter are separate components, voltage is ideally transferred from the interface of the system with the mass spectrometer to the emitter using an electrical path of electrically conductive components. Large amounts of electrically conductive materials conducting voltage near the emitter may interfere with emitter performance leading to inefficient ionization and electrospray instability. Further, electrospray emitter systems with numerous electrically conductive components without additional functions may add unnecessary manufacturing complexity and costs.

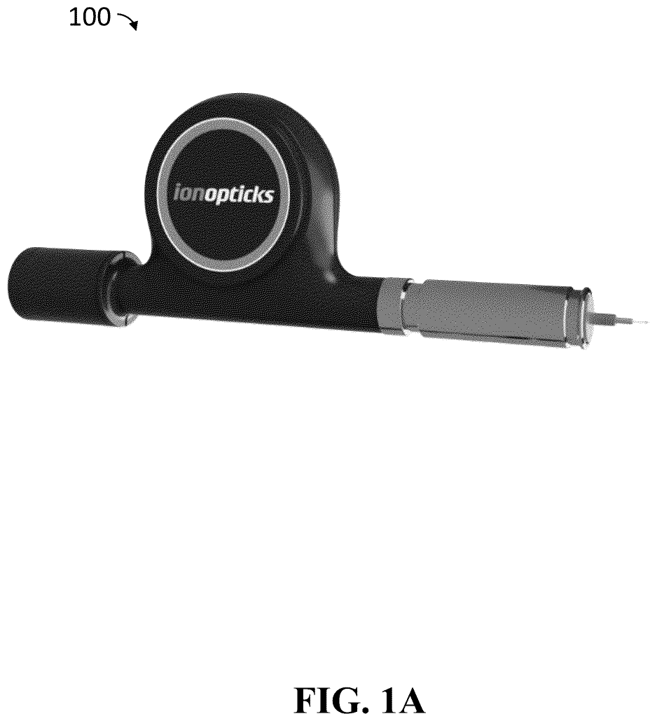

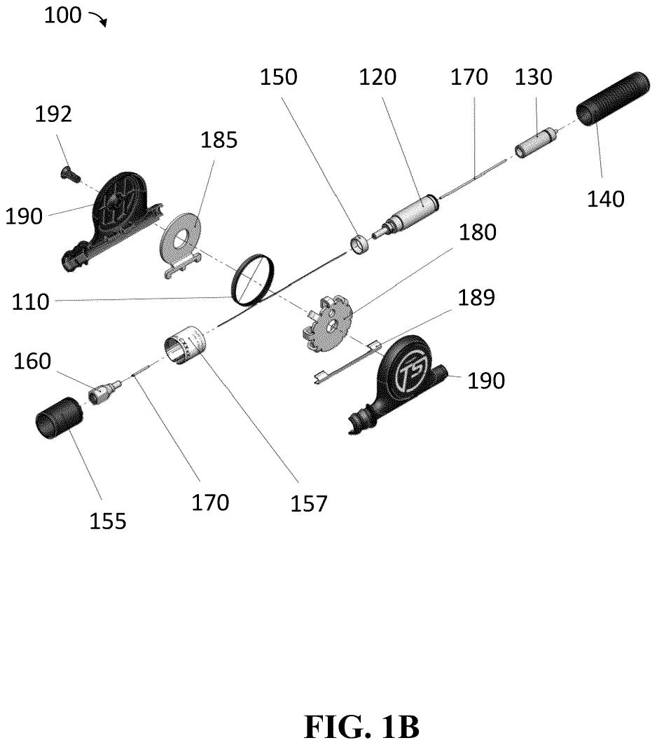

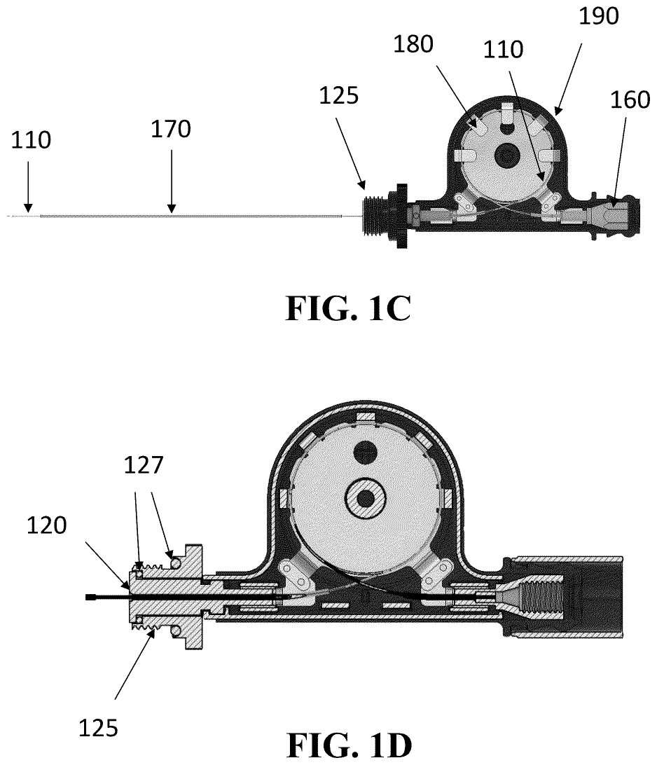

FIG. 1A and FIG. 1B show an exemplary electrospray emitter system 100 according to embodiments herein. The electrospray emitter system 100 may be configured for use in liquid chromatography with mass spectrometry. The electrospray emitter system 100 may be configured to receive a fluid and samples from a liquid chromatography system. The liquid chromatography system may be an Ultra-High Performance Liquid Chromatography (UHPLC) system. The liquid chromatography system may be a nanoElute system or a nanoElute2 system available from Bruker Corporation of Billerica, Massachusetts, an Evosep One system available from Evosep Biosystems of Odense, Denmark, a Dionex UHPLC system available from Thermo Fisher Scientific Inc. of Waltham, Massachusetts, an Easy-nLC system available from Thermo Fisher Scientific Inc. of Waltham, Massachusetts, a Vanquish Neo system available from Thermo Fisher Scientific Inc. of Waltham, Massachusetts, a M-Class system available from Waters Corporation of Milford, Massachusetts, or a nanoAcquity system available from Waters Corporation of Milford, Massachusetts, for example. The electrospray emitter system 100 may be configured to electrospray the fluid to a mass spectrometry system through an ion source. The mass spectrometry ion sources may comprise an EasySpray source available from Thermo Fisher Scientific Inc. of Waltham, Massachusetts, a Nanospray Flex source available from Thermo Fisher Scientific Inc. of Waltham, Massachusetts, an OptiFlow Turbo V source available from SCIEX of Framingham, Massachusetts, or a UniESI source available from Newomics Inc. of Berkeley, California, for example. The electrospray emitter system 100 may separate analytes and ionize the fluid using electrospray ionization.

As shown in FIG. 1B, the electrospray emitter system 100 may comprise a capillary column 110. The capillary column 110 may comprise a column. The capillary column 110 may comprise an emitter capable of electrospray emission. The column and the emitter may be integrally connected as a single component. Benefits of combining the functionality of a column and an emitter in a single component may include improved ionization efficiency, spray stability, ease of use, and/or overall system longevity. These benefits may be due to decreased dead volume. The emitter may comprise an emitter tip. The stationary phase of the chromatography column may be packed directly into the end of the emitter tip or may be held in the end of the emitter tip by a porous material, in both cases creating a packed-tip emitter. There may be a small distance between the end of the emitter tip and the stationary phase. The packed-tip emitter may also decrease the dead volume and enable the benefits of improved ionization efficiency, spray stability, and/or overall system longevity. The emitter tip may be generated by pulling the tip of the capillary column 110. The emitter tip may protrude from the electrospray emitter system 100 by at least about 2 mm, about 4 mm, about 6 mm, about 8 mm, about 10 mm, or more. The emitter tip may protrude from the electrospray emitter system 100 by no more than about 2 mm, about 4 mm, about 6 mm, about 8 mm, about 10 mm, or about 20 mm. In some embodiments, the emitter and the column may be separate components. In some embodiments where the emitter and the column are separate components, the electrospray emitter system 100 may comprise a union joint to connect the emitter and the column. The separate emitter may be made of fused silica, metal, glass, or ceramic. The separate emitter may be configured to receive voltage. The separate emitted may be coated. The separate emitter may be coated with an electrically conductive material (e.g., aluminum). The separate emitter may be coated with polyimide.

The capillary column 110 may be configured to receive fluid from a liquid chromatography system (e.g., via a fitting 160). The capillary column 110 may have a portion that is coiled in a loop. Alternatively or in addition, the capillary column 110 may have a portion that is in a wave-form. Both the coiled loop or the wave-form may enable use of longer capillary columns for greater separation lengths while using less space than a straight capillary column. Additionally, both the coiled loop or the wave-form may enable the capillary column to be more easily heated as it is in a more compact state than a straight capillary column. The capillary column 110 may have a portion that is straight (e.g., the portion of the capillary column 110 that is within the emitter collar 120). The capillary column 110 may have (i) a portion that is straight and (ii) a portion that is coiled in a loop or in a wave-form. The capillary column 110 may be from about 3 cm to 200 cm, from about 3 cm to about 10 cm, from about 10 cm to about 20 cm, from about 20 cm to about 50 cm, from about 50 cm to about 100 cm, or from about 100 cm to about 200 cm in length. The capillary column 110 may have an outer diameter of from about 150 μm to about 550 μm, from about 150 μm to about 200 μm, from about 200 μm to about 250 μm, from about 250 μm to about 300 μm, from about 300 μm to about 400 μm, or from about 400 μm to about 550 μm. The capillary column 110 may have an inner diameter of from about 2 μm to about 300 μm, from about 2 μm to about 10 μm, from about 10 μm to about 20 μm, from about 20 μm to about 50 μm, from about 50 μm to about 100 μm, from about 100 μm to about 200 μm, or from about 200 μm to about 300 μm. The capillary column 110 may be removable from the electrospray emitter system 100. Ability to remove the capillary column 110 may enable replacement of the capillary column 110 without replacement of the other components of the electrospray emitter system 100. The capillary column 110 may be made of ceramic glass, borosilicate glass, cladded fused silica, fused silica glasses, aluminosilicate glasses, glass-lined stainless steel, quartz, metal such as stainless steel, titanium, nickel, gold, or platinum, or a combination thereof. The capillary column 110 may be made of fused silica. The capillary column 110 may be coated. The capillary column 110 may be coated with an electrically conductive material (e.g., aluminum). The capillary column 110 may be coated with polyimide.

As shown in FIG. 1B, the electrospray emitter system 100 may comprise an emitter collar 120. The emitter collar 120 may be electrically conductive. The emitter collar 120 may comprise a high voltage contact point, which may comprise a recess. High voltage may be greater than about 800V. High voltage may be from about 800V to about 3000V. High voltage may be greater than about 3000V. When connected to a mass spectrometry system, the high voltage contact point may interface with a component (e.g., a ball bearing) on the mass spectrometry system. The recess in the emitter collar 120 may aid in positioning the electrospray emitter system 100 in the mass spectrometry system. The emitter collar 120 may be located at the proximal end of the electrospray emitter system 100, the emitter collar 120 may surround a portion of the capillary column 110, and/or the emitter tip may protrude from emitter collar 120. The emitter collar 120 may be made of metal (e.g., stainless steel).

As shown in FIG. 1B, the electrospray emitter system 100 may comprise an emitter locator 130. The emitter locator 130 may aid in positioning the emitter tip of the capillary column 110 such that the emitter tip protrudes from the electrospray emitter system 100. The emitter locator 130 may comprise a narrow opening at the proximal end for the capillary column 110 and may comprise a wider opening at the distal end. The narrow opening at the proximal end may be from about 0.15 mm to about 4 mm, from about 0.5 mm to about 2 mm, from about 0.5 mm to about 1.0 mm, or from about 0.8 mm to about 0.9 mm. The narrow opening at the proximal end may be about 0.85 mm. The emitter locator 130 may comprise a dead volume when the electrospray emitter system 100 is assembled. The dead volume may allow for easier manufacturing because it creates greater clearance for drilling than the narrow opening at the proximal end. The emitter locator 130 may be located at the proximal end of the electrospray emitter system 100 and may be located inside of the emitter collar 120. The emitter locator 130 may interface with the capillary column 110 and/or the emitter collar 120. The emitter locator 130 may be made of plastic (e.g., polyether ether ketone (PEEK), acrylonitrile butadiene styrene (ABS), polyoxymethylene (POM), or polypropylene (PP)). In some embodiments, the emitter collar 120 and the emitter locator 130 may be a single component. For example, the emitter collar 120 and the emitter locator 130 may be integrally connected.

As shown in FIG. 1B, the electrospray emitter system 100 may comprise an emitter cap 140. The emitter cap 140 may cover the proximal end of the electrospray emitter system 100 when not connected to a mass spectrometry system. The emitter cap 140 may provide protection to the capillary column 110 (e.g., the emitter tip). The emitter cap 140 may be removable from the assembled electrospray emitter system 100. The emitter cap 140 may be made of plastic (e.g., PEEK, ABS, POM, or PP).

As shown in FIG. 1B, the electrospray emitter system 100 may comprise a proximal collar 150. The proximal collar 150 may hold other components of the electrospray emitter system 100 in place (e.g., two halves of the outer cover 190). The proximal collar 150 may protect the user from accessing components encased within the electrospray emitter system 100 (e.g., the fitting 160), which may reduce the risk of the user contacting the voltage. The proximal collar 150 may interface with the emitter collar 120 at the distal end of the emitter collar 120. The proximal collar 150 may be made of metal (e.g., stainless steel). The proximal collar 150 may be made of plastic (e.g., PEEK, ABS, POM, or PP).

As shown in FIG. 1B, the electrospray emitter system 100 may comprise a distal collar 155. The distal collar 155 may be located at the distal end of the electrospray emitter system 100 and may surround a fitting 160. The distal collar 155 may interface with the fitting 160. The distal collar 155 may provide protection for the fitting 160. The distal collar 155 may comprise a label 157. The distal collar 155 may be made of plastic (e.g., PEEK, ABS, POM, or PP).

As shown in FIG. 1B, the electrospray emitter system 100 may comprise a fitting 160. For example, the fitting may be a fitting as described in U.S. Patent Publication No. U.S. Pat. No. 11,819,780B2, the contents of which are incorporated herein by reference. The fitting 160 may be located at the distal end of the electrospray emitter system 100. The fitting 160 may interface with a liquid chromatography system and the capillary column 110. The fitting 160 may comprise a capillary column recess for receiving an end of the capillary column 110. The fitting 160 may comprise a liquid chromatography recess (e.g., a female union) for connecting to the liquid chromatography system. Alternatively, the fitting 160 may comprise a male union for connecting to the liquid chromatography system. The fitting 160 may comprise a passage between (i) the capillary column recess and (ii) the liquid chromatography recess or male union. The passage may be configured to allow fluid to flow through and directly contact the passage during operation. The fitting 160 may electrically contact the fluid flowing through the fitting 160, thereby transferring voltage from the fitting 160 to the fluid during operation. The fitting 160 may be electrically conductive. The fitting 160 may be made of metal (e.g., stainless steel). The fitting 160 may be configured such that there is minimal or even zero dead volume between the liquid chromatography system and the capillary column. Benefits of minimal or even zero dead volume may include a reduction in chromatographic peak widths and improved peak symmetry.

As shown in FIG. 1B, the electrospray emitter system 100 may comprise one or more sleeves 170. The one or more sleeves 170 may provide protection for the capillary column 110 (e.g., during shipping) or may crimp the capillary column 110 into position. The one or more sleeves 170 may be made of a compliant material (e.g., plastic such as PEEK). Use of a compliant material for the sleeves may prevent damage to other components (e.g., the capillary column 110) during assembly of the electrospray emitter system 100. The one or more sleeves 170 may be located near the distal end of the capillary column 110 and/or near the proximal end of the capillary column 110. The one or more sleeves 170 may surround and interface with the capillary column 110. The sleeve 170 at the distal end of the capillary column 110 may be inside the capillary column recess of the fitting 160 and may be used to provide a seal between the capillary column 110 and the fitting 160. The sleeve 170 at the proximal end of the capillary column 110 may be inside the emitter collar 120 and may be used to provide a seal between the capillary column 110 and the emitter collar 120, which may enable the emitter to be held in the desired position.

As shown in FIG. 1B, the electrospray emitter system 100 may comprise a column holder 180. The column holder may hold a portion of the capillary column 110 (e.g., when the capillary column 110 is in a coil). The column holder 180 may comprise a flat circular plate and hooks for holding the capillary column 110. The hooks may extend perpendicular to the flat circular plate and curve such that the end of the hook is parallel to the flat circular plate. The column holder 180 may comprise a hole in the center for a screw. The column holder 180 may be heated to provide heat to the capillary column 110. For example, the column holder 180 may be heated indirectly using a separate heater. The column holder 180 may be made of metal (e.g., aluminum, stainless steel, copper, or brass).

As shown in FIG. 1B, the electrospray emitter system 100 may comprise a cover plate 185. The cover plate 185 may comprise a flat circular plate. The cover plate 185 may comprise a hole in the center for a screw. The cover plate 185 may interface with the column holder 180. For example, the flat surface of the cover plate 185 may interface with the hooks of the column holder 180. The cover plate 185 may be heated to provide heat to the capillary column 110. The cover plate 185 may be made of metal (e.g., aluminum, stainless steel, copper, or brass). The cover plate 185 may be made of thermoconductive plastics (e.g., polyphenylene sulfide).

As shown in FIG. 1B, the electrospray emitter system 100 may comprise a voltage bridge 189. The voltage bridge 189 may interface with the emitter collar 120 (or various electrically conductive components contacting the emitter collar as described herein) and the fitting 160, providing an electrical path between the emitter collar 120 (or various electrically conductive components contacting the emitter collar as described herein) and the fitting 160. The voltage bridge 189 may be made of metal (e.g., aluminum, stainless steel, copper, brass). The voltage bridge 189 may be made of electrically conductive plastics (e.g., Polyetheretherketone with embedded carbon).

As shown in FIG. 1B, the electrospray emitter system 100 may comprise an outer cover 190. The outer cover 190 may provide protection for and encase various components of the electrospray emitter system 100 (e.g., the capillary column 110). The outer cover 190 may comprise multiple separate components. For example, the outer cover 190 may comprise two sides (as shown in FIG. 1B), which may allow for easier assembly. The two sides of the outer cover 190 may enclose a majority of the capillary column 110, the column holder 180, and the cover plate 185. A screw 192 may be used to connect the two sides of the outer cover 190. Alternatively, the outer cover 190 may be a single component. Other components of the system (e.g., everything except the outer cover) may be molded and embedding in the single component outer cover. The outer cover 190 may be made of plastic (e.g., polyphenylene sulfide). The plastic used may allow for higher thermal conductivity than other plastics to aid in the heat transfer to the capillary column 110. Additionally, a thermoconductive material (e.g., epoxy) may be placed inside of the outer cover 190 and allowed to set, which may improve the assembly process (e.g., by improving consistency or ease of manufacture) and/or improve the conductance of heat throughout the system.

As shown in FIGS. 1C and 1D, the electrospray emitter system may comprise a screw fitting 125. The screw fitting 125 may be located around the emitter collar 120. The screw fitting 125 may interface with a female recess on a mass spectrometry system (e.g., an ion source) and may be configured to attach and secure the electrospray emitter system to the mass spectrometry system. The electrospray emitter system may comprise one or more o-rings 127. The o-ring(s) 127 may be positioned between the emitter collar 120 and the screw fitting 125 and/or at an interface between the screw fitting 125 and a mass spectrometry system. The o-ring(s) 127 may enable a seal (e.g., an air-tight seal) between the electrospray emitter system and the mass spectrometry system. The proximal end of the emitter collar 120 may be flat or conical. The flat or conical surface of the emitter collar 120 may interface with a mass spectrometry system (e.g., an ion source) and may be configured to receive high voltage. High voltage may be greater than about 800V. High voltage may be from about 800V to about 3000V. High voltage may be greater than about 3000V. The capillary column 110 may protrude from the electrospray emitter system by at least about 1 cm, about 2 cm, about 3 cm, about 4 cm, about 5 cm, about 6 cm, about 8 cm, about 10 cm, about 12 cm, or about 15 cm. The capillary column 110 may protrude from the electrospray emitter system by about 9 cm. The sleeve 170 may cover a portion of the capillary column that extends from the electrospray emitter system (e.g., during shipping), and may be positioned to simultaneously have a portion that is inside of the emitter collar 120 and a portion that extends from the emitter collar 120 (e.g., during use).

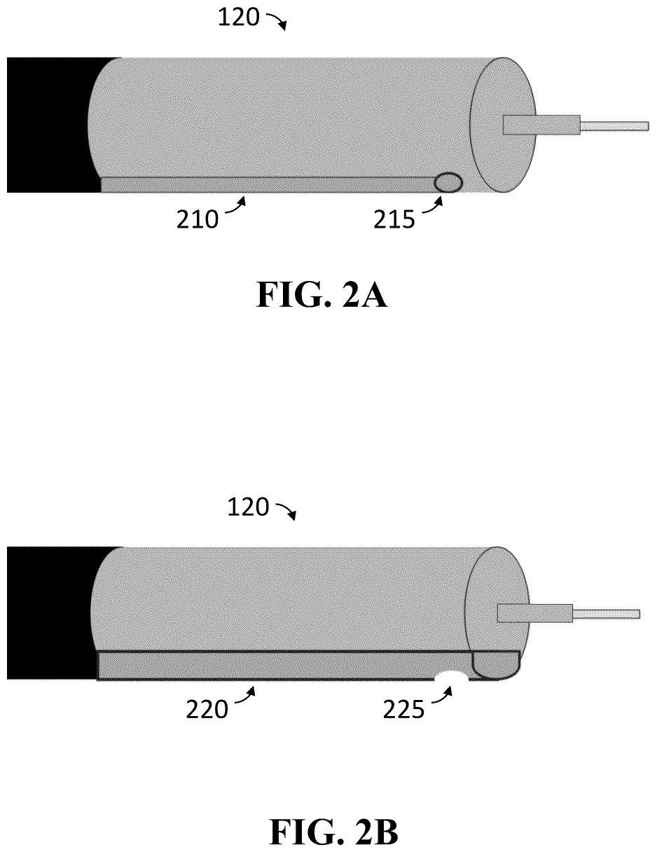

In some embodiments, as shown in FIG. 2A, the electrospray emitter system 100 may further comprise an electrically conductive strip 210. The electrically conductive strip 210 may provide an electrical path. The electrically conductive strip 210 may be embedded into the outer surface of emitter collar 120. The electrically conductive strip 210 may interface with the voltage bridge 189 (or various electrically conductive elements as described herein). The electrically conductive strip 210 may comprise a high voltage contact point 215, which may comprise a recess. When connected to a mass spectrometry system, the high voltage contact point may interface with a component (e.g., a ball bearing) on the mass spectrometry system. The recess in the electrically conductive strip 210 may aid in positioning the electrospray emitter system 100 in the mass spectrometry system. The electrically conductive strip 210 may be made of metal (e.g., stainless steel). In some embodiments with an electrically conductive strip 210, the emitter collar 120 may be made of plastic. Benefits of an electrospray emitter system comprising a plastic emitter collar 120 and an electrically conductive strip 210 may include increased performance of the emitter due to the decrease in metal near the emitter tip. In some embodiments, the electrically conductive strip 210 may be located inside of the emitter collar 120, and the emitter collar 120 may have an aperture to expose the high voltage contact point 215.

In some embodiments, as shown in FIG. 2B, the electrospray emitter system 100 may further comprise an electrically conductive rail 220. The electrically conductive rail 220 may provide an electrical path. The electrically conductive rail 220 may be mounted to the outer surface of emitter collar 120. The electrically conductive rail 220 may interface with the voltage bridge 189 (or various electrically conductive alternatives as described herein). The electrically conductive rail 220 may comprise a high voltage contact point 225, which may comprise a recess. When connected to a mass spectrometry system, the high voltage contact point may interface with a component (e.g., a ball bearing) on the mass spectrometry system. The recess in the electrically conductive rail 220 may aid in positioning the electrospray emitter system 100 in the mass spectrometry system. The electrically conductive rail 220 may be made of metal (e.g., stainless steel). In some embodiments with an electrically conductive rail 220, the emitter collar 120 may be made of plastic. Benefits of an electrospray emitter system comprising a plastic emitter collar 120 and an electrically conductive rail 220 may include increased performance of the emitter due to the decrease in metal near the emitter tip. In some embodiments, the electrically conductive rail 220 may be located inside of the emitter collar 120, and the emitter collar 120 may have an aperture to expose the high voltage contact point 225.

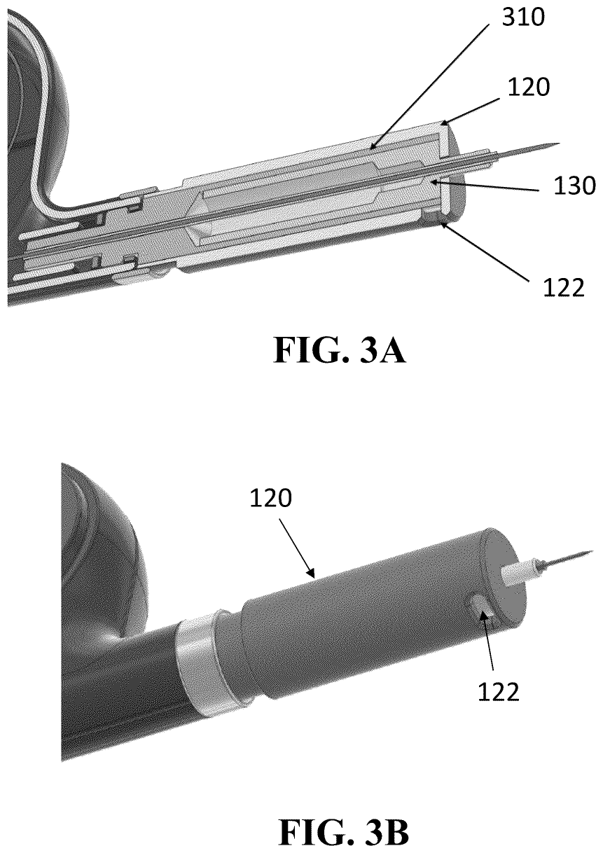

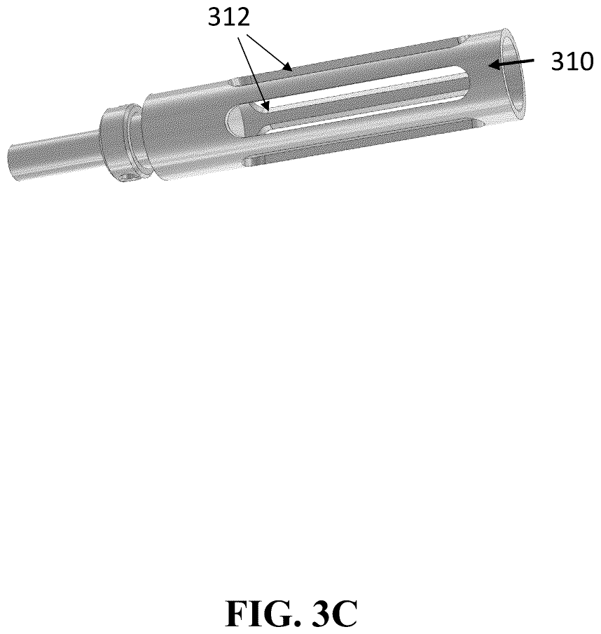

In some embodiments, as shown in FIG. 3A and FIG. 3B, the electrospray emitter system 100 may further comprise an electrically conductive inner frame 310. The electrically conductive inner frame 310 may provide an electrical path. The electrically conductive inner frame 310 may be located in between the emitter collar 120 and the emitter locator 130 and may interface with the emitter collar 120 and the emitter locator 130. The electrically conductive inner frame 310 may interface with the voltage bridge 189 (or various electrically conductive alternatives as described herein). The electrically conductive inner frame 310 may comprise a high voltage contact point. The emitter collar 120 may have an aperture 122 to expose the high voltage contact point. When connected to a mass spectrometry system, the high voltage contact point may interface with a component (e.g., a ball bearing) on the mass spectrometry system through the aperture 122 in the emitter collar 120. The aperture 122 in the emitter collar 120 may aid in positioning the electrospray emitter system 100 in the mass spectrometry system. The electrically conductive inner frame 310 may be made of metal (e.g., stainless steel). In some embodiments with an electrically conductive inner frame 310, the emitter collar 120 may be made of plastic. Benefits of an electrospray emitter system comprising a plastic emitter collar 120 and an electrically conductive inner frame 310 may include increased performance of the emitter due to the decrease in the amount of metal near the emitter tip.

As shown in FIG. 3C, the electrically conductive inner frame 310 may comprise a cylindrical component. The cylindrical component may be hollow, allowing for the emitter locator 130 to fit inside. The cylindrical component may comprise 1, 2, 3, 4, 5, 6, 7, 8, 9, 10 or more cut outs 312. The cut outs 312 may be symmetric. Alternatively, the cut outs 312 may be asymmetric. The length of the cut outs 312 may be at least about 10%, 20%, 30%, 40%, 50%, 60%, 70% or more of the length of the electrically conductive inner frame 310. The width of the cut outs 312 may be at least about 5%, 10%, 20%, 30%, 40%, 50%, 60%, 70%, 80%, 90% or more of the circumference of the electrically conductive inner frame 310. In some embodiments, the cuts out reduce the amount of metal of the electrically conductive inner frame 310 by at least about 5%, 10%, 15%, 20%, 25%, 30%, 40%, 50%, 60%, 70%, 80%, 90%, or more relative to an electrically conductive inner frame with the same shape but without cut outs. Benefits of the cut outs 312 may include increased performance of the emitter due to the decrease in the amount of metal near the emitter tip.

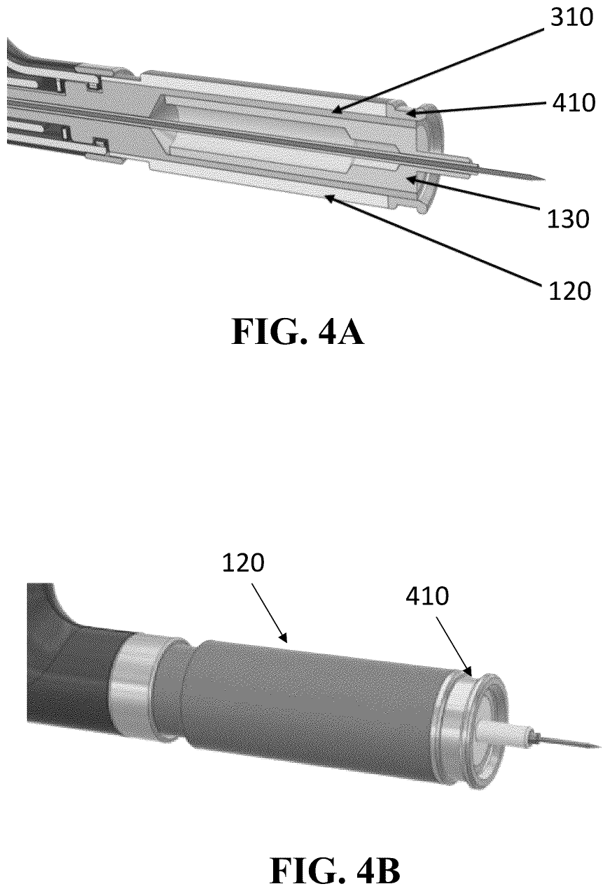

In some embodiments, as shown in FIG. 4A and FIG. 4B, the electrospray emitter system 100 may further comprise an electrically conductive inner frame 310 and an electrically conductive ring 410. The electrically conductive inner frame 310 and the electrically conductive ring 410 may provide an electrical path. The electrically conductive inner frame 310 may be positioned between the emitter collar 120 and the emitter locator 130 and may interface with the emitter collar 120 and the emitter locator 130. The electrically conductive inner frame 310 may interface with the voltage bridge 189 (or various electrically conductive alternatives as described herein). The electrically conductive ring 410 may be located around the proximal end of the emitter collar 120 and may interface the outside of the electrically conductive inner frame 310. The electrically conductive ring 410 may be a press-fit or threaded ring. When connected to a mass spectrometry system, the electrically conductive ring 410 may interface with a component (e.g., a ball bearing) on the mass spectrometry system. The electrically conductive ring 410 may comprise a groove, which may aid in positioning the electrospray emitter system 100 in the mass spectrometry system. The groove may be along the entire circumference of the electrically conductive ring 410. The groove may be along about 5%, 10%, 20%, 30%, 40%, 50% or more of the circumference of the electrically conductive ring 410. The electrically conductive inner frame 310 and/or the electrically conductive ring 410 may be made of metal (e.g., stainless steel). In some embodiments with an electrically conductive inner frame 310 and an electrically conductive ring 410, the emitter collar 120 may be made of plastic. Benefits of an electrospray emitter system comprising a plastic emitter collar 120, an electrically conductive inner frame 310, and an electrically conductive ring 410 may include increased performance of the emitter due to the decrease in the amount of metal near the emitter tip.

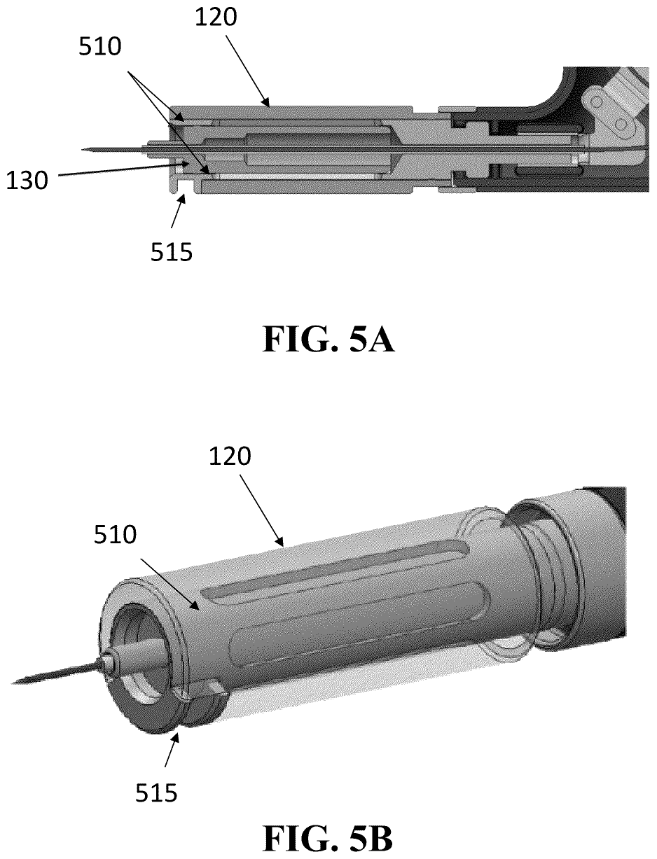

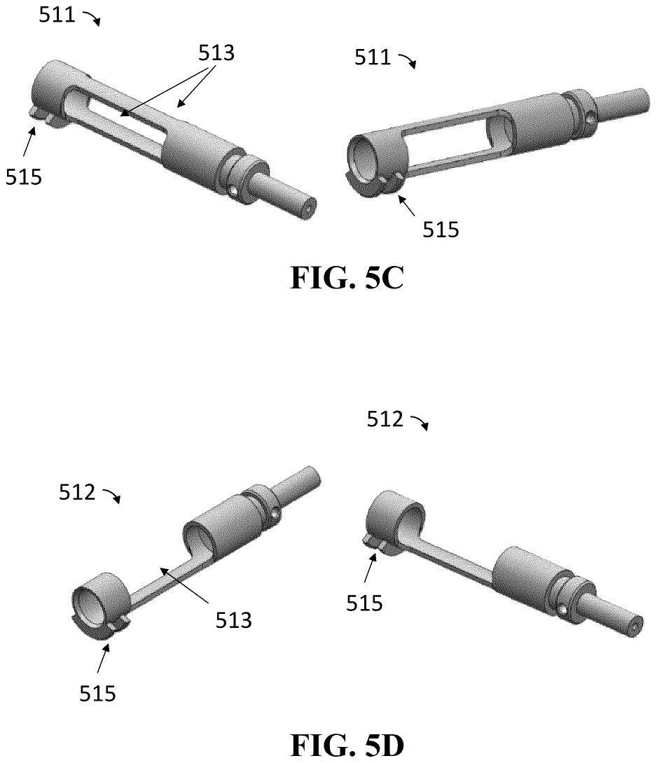

In some embodiments, as shown in FIG. 5A and FIG. 5B, the electrospray emitter system 100 may further comprise an electrically conductive inner frame with a contact groove 510. The electrically conductive inner frame with a contact groove 510 may provide an electrical path. The electrically conductive inner frame with a contact groove 510 may be located in between the emitter collar 120 and the emitter locator 130 and may interface with the emitter collar 120 and the emitter locator 130. The electrically conductive inner frame with a contact groove 510 may interface with the voltage bridge 189 (or various electrically conductive alternatives as described herein). The contact groove 515 of the electrically conductive inner frame with a contact groove 510 may be located at the proximal end of the emitter collar 120. The contact groove 515 may comprise two fins that protrude from the body of the electrically conductive inner frame. The width of the contact groove 515 may be at least about 10%, 20%, 30%, 40%, 50% or more of the circumference of the electrically conductive inner frame with a contact groove 510. The contact groove 515 may be along the entire circumference of the electrically conductive inner frame with a contact groove 510. When connected to a mass spectrometry system, the contact groove 515 may interface with a component (e.g., a ball bearing) on the mass spectrometry system. The contact groove 515 may aid in positioning the electrospray emitter system 100 in the mass spectrometry system. The electrically conductive inner frame with a contact groove 510 may be made of metal (e.g., stainless steel). In some embodiments with an electrically conductive inner frame with a contact groove 510, the emitter collar 120 may be made of plastic. Benefits of an electrospray emitter system comprising a plastic emitter collar 120 and an electrically conductive inner frame with a contact groove 510 may include increased performance of the emitter due to the decrease in the amount of metal near the emitter tip.

As shown in FIGS. 5C and 5D, the electrically conductive inner frame with a contact groove 510 may comprise a cylindrical component. The cylindrical component may be hollow, allowing for the emitter locator 130 to fit inside. The cylindrical component may comprise 1, 2, 3, 4, 5, 6, 7, 8, 9, 10 or more cut outs 513. An exemplary electrically conductive inner frame with a contact groove with two cut outs 511 is shown in FIG. 5C. An exemplary electrically conductive inner frame with a contact groove with one cut out 512 is shown in FIG. 5D. The cut outs 513 may be symmetric. Alternatively, the cut outs 312 may be asymmetric. The length of the cut outs 513 may be at least about 10%, 20%, 30%, 40%, 50%, 60%, 70% or more of the length of the electrically conductive inner frame with a contact groove 510. The width of the cut outs 513 may be at least about 5%, 10%, 20%, 30%, 40%, 50%, 60%, 70%, 80%, 90% or more of the circumference of the electrically conductive inner frame with a contact groove 510. Benefits of the cut outs 513 may include increased performance of the emitter due to the decrease in the amount of metal near the emitter tip.

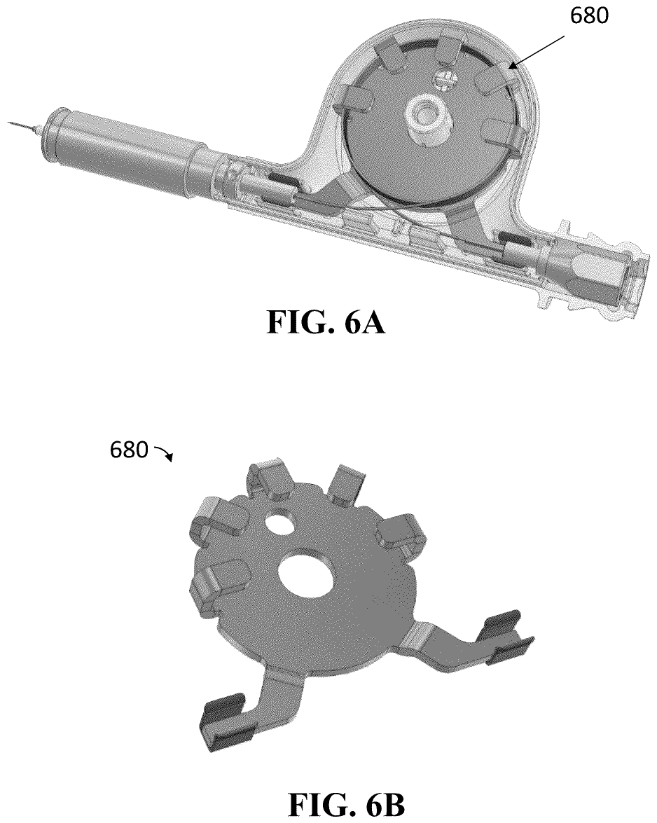

In some embodiments, as shown in FIG. 6A and FIG. 6B, the electrospray emitter system 100 may comprise an electrically conductive column holder 680. The electrically conductive column holder 680 may interface with the emitter collar 120 (or various electrically conductive components contacting the emitter collar as described herein) and the fitting 160, providing an electrical path between the emitter collar 120 (or various electrically conductive components contacting the emitter collar as described herein) and the fitting 160. In some embodiments with an electrically conductive column holder 680, the electrospray emitter system 100 may not have a separate voltage bridge 189 as the electrically conductive column holder 680 may perform the function of the voltage bridge 189. Benefits of having an electrically conductive column holder 680 instead of a voltage bridge 189 may include ease of manufacturing as there are less components. The electrically conductive column holder 680 may hold the capillary column 110 (e.g., when the capillary column 110 is in a coil). The column holder 680 may comprise a flat circular plate and hooks for holding the capillary column 110. The hooks may extend perpendicular to the flat circular plate and curve such that the end of the hook is parallel to the flat circular plate. The column holder 680 may comprise a hole in the center for a screw. The column holder 680 may be heated to provide heat to the capillary column 110. The column holder 680 may be made of metal (e.g., aluminum).

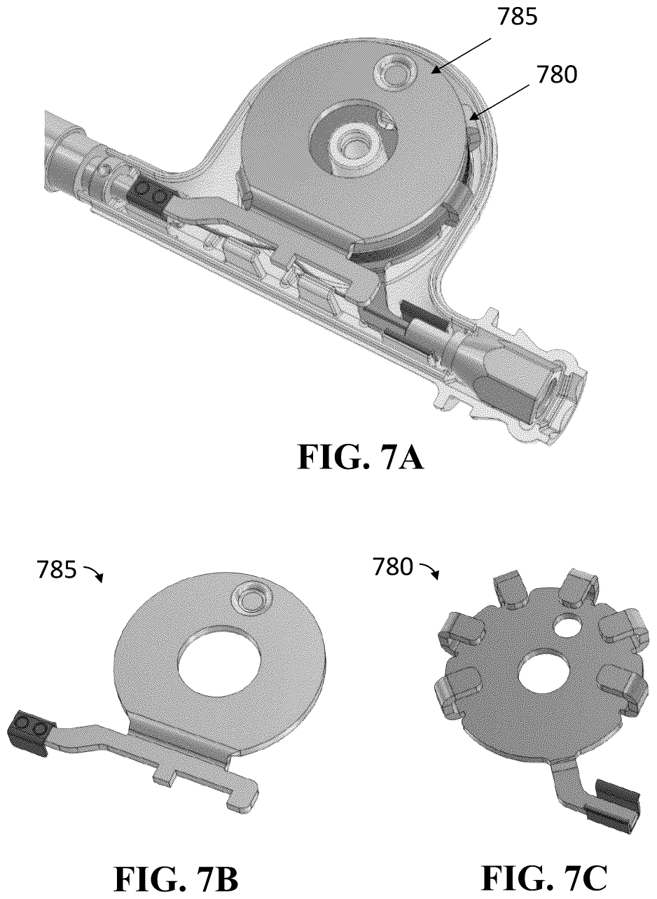

In some embodiments, as shown in FIGS. 7A-7C, the electrospray emitter system 100 may comprise an electrically conductive column holder 780 and an electrically conductive cover plate 785. The electrically conductive column holder 780 may interface with the electrically conductive cover plate 785. For example, the flat surface of the electrically conductive cover plate 785 may interface with hooks of the electrically conductive column holder 780. The electrically conductive column holder 780 and the electrically conductive cover plate 785 may interface with the emitter collar 120 (or various electrically conductive components contacting the emitter collar as described herein) and the fitting 160, providing an electrical path between the emitter collar 120 (or various electrically conductive components contacting the emitter collar as described herein) and the fitting 160. In some embodiments with an electrically conductive column holder 780 and an electrically conductive cover plate 785, the electrospray emitter system 100 may not have a separate voltage bridge 189 as the electrically conductive column holder 680 and the electrically conductive cover plate 685 may perform the function of the voltage bridge 189. Benefits of having an electrically conductive column holder 680 instead of a voltage bridge 189 may include ease of manufacturing as there are less components. The electrically conductive column holder 780 may hold the capillary column 110 (e.g., when the capillary column 110 is in a coil). The electrically conductive column holder 780 may comprise a flat circular plate and hooks for holding the capillary column 110. The hooks may extend perpendicular to the flat circular plate and curve such that the end of the hook is parallel to the flat circular plate. The electrically conductive column holder 780 and the electrically conductive cover plate 785 may have a hole in the center for a screw. The electrically conductive column holder 780 and the electrically conductive cover plate 785 may be heated to provide heat to the capillary column 110. The electrically conductive column holder 780 and the electrically conductive cover plate 785 may be made of metal (e.g., aluminum).

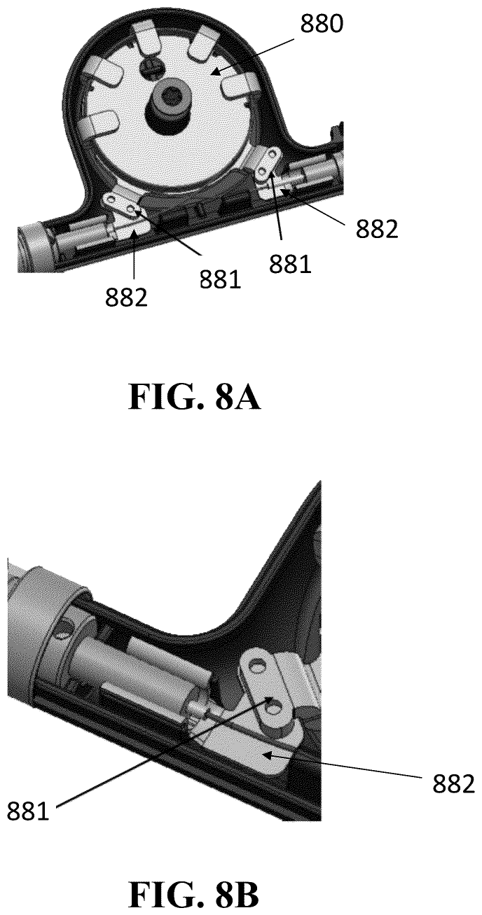

In some embodiments, as shown in FIG. 8A and FIG. 8B, the electrically conductive column holder 880 may comprise a first side of a claw clip 882. The first side of the claw clip 882 may be located at the interface with a component contacting the emitter collar 120 (or various electrically conductive components contacting the emitter collar as described herein) and/or at the interface with a component contacting the fitting 160. The component contacting the emitter collar 120 (or various electrically conductive components contacting the emitter collar as described herein) and/or the component contacting the fitting 160 may comprise a second side of a claw clip 881. The claw clips may be used to attach the electrically conductive column holder 880 to components contacting the emitter collar 120 (or various electrically conductive components contacting the emitter collar as described herein) and/or the fitting 160. In some embodiments wherein the electrospray emitter system 100 comprises an electrically conductive column holder and an electrically conductive cover plate, the electrically conductive cover plate may comprise a first side of a claw clip that may interface with a component contacting the emitter collar 120 (or various electrically conductive components contacting the emitter collar as described herein) and/or the fitting 160. In some embodiments wherein the electrospray emitter system 100 comprises a voltage bridge 189, the voltage bridge 189 may comprise a first side of a claw clip that may interface with a component contacting the emitter collar 120 (or various electrically conductive components contacting the emitter collar as described herein) and/or the fitting 160. The claw clips may decrease the likelihood of separation between components joined by the claw clips (e.g., during assembly, shipment, or use) without the need for welding. Separation of components may disrupt the electrical path.

In some embodiments, the electrospray emitter system 100 may be configured to interface with a heater. The heater may provide heat to the column holder 180, the electrically conductive column holder 680 or 780, the cover plate 185, and/or the electrically conductive cover plate 785 or 880.

In some embodiments, at least one component of the electrospray emitter system is made of plastic. Suitable plastics include but are not limited to PEEK, ABS, POM, PP, and polyphenylene sulfide.

In some embodiment, at least one component of the electrospray emitter system is made of a compliant material. Suitable compliant materials include but are not limited to polyethylene terephthalate; polyethylene, such as high density polyethylene (HDPE) or low density polyethylene (LDPE); polyvinyl chloride; polypropylene; and polystyrene. The compliant material may comprise a polymer selected from the group consisting of polyimides, fluoropolymers, polyaryletherketones (PAEK) and mixtures thereof. In some embodiments, the compliant material may comprise a polyaryletherketone, and the polyaryletherketone may be selected from the group consisting of polyetherketone (PEK), polyetheretherketone (PEEK) and polyetherketoneketone (PEKK).

In some embodiments, at least one component of the electrospray emitter system is made of metal. Suitable metals include but are not limited to stainless steel, aluminum, titanium, nickel, gold, brass, copper, and platinum.

In some embodiments, components of the electrospray emitter system are joined together via press fitting, interference fitting, crimping, screwing, fastening, clamping, binding, riveting, bolting, welding, gluing, stapling, bracing, or soldering.

While preferred embodiments of the present disclosure have been shown and described herein, it will be obvious to those skilled in the art that such embodiments are provided by way of example only. It is not intended that the invention be limited by the specific examples provided within the specification. While various embodiments have been described with reference to the aforementioned specification, the descriptions and illustrations of the embodiments herein are not meant to be construed in a limiting sense. Numerous variations, changes, and substitutions will now occur to those skilled in the art without departing from the scope of the present disclosure. Furthermore, it shall be understood that all aspects of the present disclosure are not limited to the specific depictions, configurations or relative proportions set forth herein which depend upon a variety of conditions and variables. It should be understood that various alternatives to the embodiments of the present disclosure described herein may be employed in practicing the invention. It is therefore contemplated that the scope of the present disclosure shall also cover any such alternatives, modifications, variations, or equivalents. It is intended that the following claims define the scope of the invention and that methods and structures within the scope of these claims and their equivalents be covered thereby.

1.-19. (canceled)

20. An electrospray emitter system comprising:
an emitter;
a column connected to the emitter;
a non-conductive emitter collar comprising non-electrically conductive material, wherein at least of a portion of the emitter or the column are positioned within the emitter collar; and
an electrically conductive inner frame, wherein the electrically conductive inner frame is positioned within the emitter collar and around at least a portion of the emitter or the column, and wherein the electrically conductive inner frame provides an electrical path toward the emitter.

21. The electrospray emitter system of claim 20, wherein the electrically conductive inner frame is hollow.

22. The electrospray emitter system of claim 20 wherein the electrically conductive inner frame comprises one or more cut outs.

23. The electrospray emitter system of claim 20, further comprising a voltage bridge and an electrically conductive fitting.

24. The electrospray emitter system of claim 23, wherein the electrically conductive inner frame, the voltage bridge, and the electrically conductive fitting are interfacing such that the electrically conductive inner frame, the voltage bridge, and the electrically conductive fitting operate as the electrical path.

25. The electrospray emitter system of any one of claim 20, wherein the electrically conductive inner frame comprises a high voltage contact point.

26. The electrospray emitter system of claim 25, wherein the emitter collar has an aperture through which the high voltage contact point is outwardly exposed.

27. The electrospray emitter system of claim 26, wherein the aperture and the high voltage contact point comprise an interface to a mass spectrometry system.

28. The electrospray emitter system of claim 20, wherein the electrically conductive inner frame comprises a contact groove for interfacing with a mass spectrometry system.

29. The electrospray emitter system of claim 20, further comprising an electrically conductive ring.

30. The electrospray emitter system of claim 29, wherein the electrically conductive ring is located around the proximal end of the emitter collar.

31. The electrospray emitter system of claim 29, wherein the electrically conductive ring is a press-fit or threaded ring.

32. The electrospray emitter system of claim 29, wherein the electrically conductive ring comprises a groove for interfacing with a mass spectrometry system.

33. The electrospray emitter system of claim 29, wherein the electrically conductive ring, the electrically conductive inner frame, the voltage bridge, and the electrically conductive fitting are interfacing such that the electrically conductive ring, the electrically conductive inner frame, the voltage bridge, and the electrically conductive fitting operate as the electrical path.

34. The electrospray emitter system of claim 20, wherein the column and the emitter are integrally connected as a single component.

35. The electrospray emitter system of claim 20, wherein the emitter comprises a packed-tip emitter.

36. An electrospray emitter system comprising:
an emitter;
a column connected to the emitter; and
an electrically conductive column holder providing an electrical path toward the emitter, wherein at least a portion of the column interfaces with the column holder.

37. The electrospray emitter system of claim 36, further comprising an electrically conductive fitting and at least one other electrically conductive component.

38. The electrospray emitter system of claim 37, wherein the at least one other electrically conductive component is one or more of an emitter collar, an electrically conductive strip, an electrically conductive rail, or an electrically conductive inner frame.

39. The electrospray emitter system of claim 36, wherein the column holder comprises a first side of a claw clip.

40. The electrospray emitter system of claim 37, wherein the at least one other electrically conductive component, the electrically conductive column holder, and the electrically conductive fitting are interfacing such that the at least one other electrically conductive component, the electrically conductive column holder, and the electrically conductive fitting operate as the electrical path.

41. The electrospray emitter system of claim 36, further comprising an electrically conductive cover plate.

42. The electrospray emitter system of claim 41, wherein the at least one other electrically conductive component, the electrically conductive column holder, the electrically conductive cover plate, and the electrically conductive fitting are interfacing such that the at least one other electrically conductive component, the electrically conductive column holder, the electrically conductive cover plate, and the electrically conductive fitting operate as the electrical path.

43. The electrospray emitter system of claim 36, wherein the column and the emitter are integrally connected a single component.

44. The electrospray emitter system of claim 36, wherein the emitter comprises a packed-tip emitter.
